(19) United States
(12) Patent Application Publication
(10) Pub. No.: US 2011/0192127 A1
(43) Pub. Date: Aug. 11, 2011

(54) STAINLESS STEEL FOR FILTER APPLICATIONS

(75) Inventors: Owe Mårs, Hoganas (SE); Ingrid Hauer, Helsingborg (SE)

(73) Assignee: HÖGANÄS AB, Hoganas (SE)

(21) Appl. No.: 13/090,749

(22) Filed: Apr. 20, 2011

Related U.S. Application Data
(63) Continuation of application No. 11/922,338, filed on Feb. 4, 2008.
(60) Provisional application No. 60/716,509, filed on Sep. 14, 2005.

(30) Foreign Application Priority Data
Jul. 1, 2005 (SE) 0501543-3

(51) Int. Cl. B01D 39/20; B01D 46/00; F01N 3/00; C22C 38/58; C22C 38/40; C22C 38/38; C22C 38/18; C22C 30/00

(52) U.S. Cl. 55/523; 420/44; 420/50; 420/43; 420/56; 420/34; 420/584.1

(57) ABSTRACT

A filter comprising a porous sintered stainless steel is provided. The filter includes 10-30% chromium, 5-25% nickel, 0.5-3% manganese; 1-4% silicon, and 0-3% molybdenum with the remainder being iron and inevitable impurities. The sintered steel has a density less than 80% of full density. The use of a stainless steel powder for the preparation of a filter having improved permeability at high temperatures also is described.

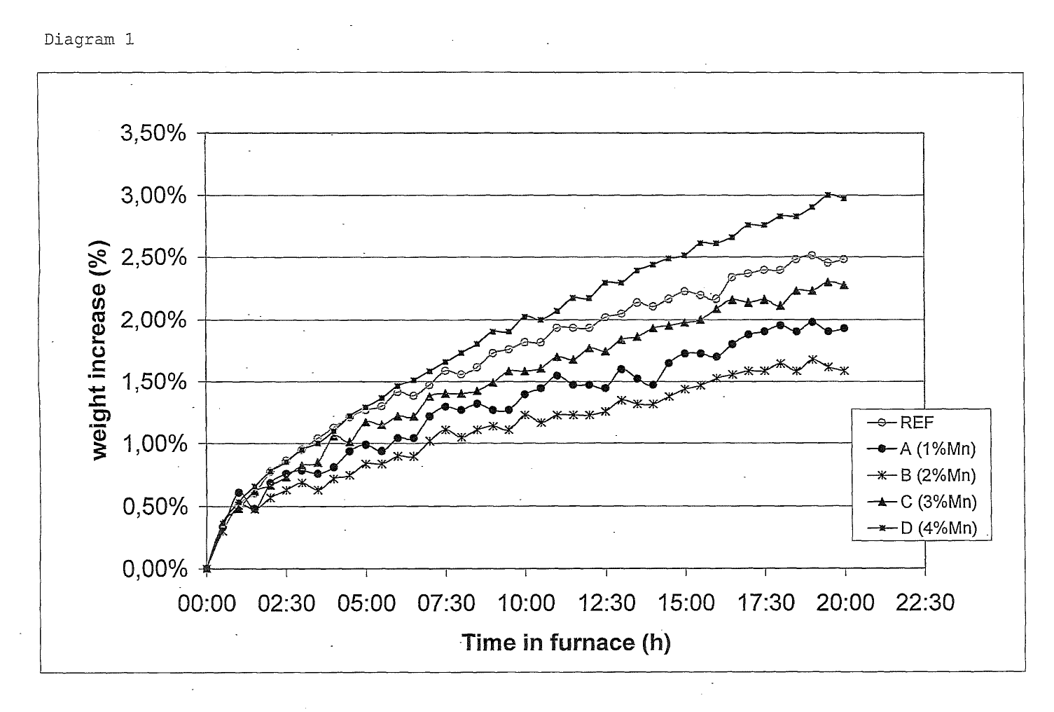

### FIELD OF THE INVENTION

The invention relates to materials for filter. Specifically the invention concerns materials for filters for removing harmful constituents from combustion engines.

### BACKGROUND OF THE INVENTION

In the modern society the use of internal combustion engines is common in e.g. passenger cars and commercial vehicles. For environmental reasons it is of great interest to reduce harmful constituents from the combustion gases from the engines. Therefore much effort is put on the reduction of particles which are emitted from engines, especially from diesel engines as particles from diesel engines, e.g. carbon deposits, are considered to be a particular environmental problem.

Filters, which are available today for filtering particles from diesel engines are commonly made of ceramics, such as silicon carbide. The particles, which are captured in the filter, can be removed by combustion at high temperature. A problem encountered with ceramic filters is lack of thermal and mechanical shock resistance. The ceramic filters also have limitations in geometry, i.e. there are limitations as to the configuration of the filter.

Many different filters concerning the filter configuration are known, see e.g. the U.S. Pat. Nos. 5,215,724, 5,405,423, 5,204,067, 5,240,485, 5,009,857. The material selection of the filters is however only superficially discussed and the chemical composition of the filter is not specifically discussed. Thus in e.g. the U.S. Pat. No. 5,266,279 it is mentioned that steel consisting of 20% of nickel and 25% of chromium, the remainder being iron and traces of manganese and molybdenum, can be used as a material for the filter supporting wires, which are supporting a sintering material, which may be made of metals, ceramic materials, plastics or mixtures thereof.

The lifetime of a filter is determined of the decrease of the permeability of gas through the filter. When exposed to oxidising gases at high temperature the oxides grow on the surface of the metal filling. This means that the porosity and thus the permeability of gas through the filter are decreased. Therefore, a less oxide formation will result in improved performance and increased lifetime of the filter.

### SUMMARY OF THE INVENTION

It has now surprisingly been found that a sintered filter material having improved lifetime may be obtained, if the material includes carefully controlled amounts of manganese. Specifically the manganese content should be between 0.5 and 3% by weight of the sintered steel. By adding manganese in this range the permeability will be maintained during a longer time of use due to less oxidation of the sintered steel. Other elements of the sintered steel are 10-30% by weight of chromium, 5-25% by weight of nickel, 1-4% by weight of silicon and 0-3% by weight of molybdenum. The amount of inevitable impurities are normally less than 2% by weight, preferably less than 0.5% by weight.

The filter may also have a density less than 70% of full density. Preferably the density is between 25 and 60% of full density. Higher density will not give enough permeability of gas and lower density gives too low filtering efficiency and low mechanical strength. Within this density range the permeability of the filter will be sufficient.

Furthermore the filter may include reinforcement which enhances the strength of the filter. The reinforcement may be in the form of fibres, wire or mesh.

### DETAILED DESCRIPTION OF THE INVENTION

The powders used for the preparation of the sintering material according to the invention are stainless steel powders having an elevated, controlled manganese content. Specifically these powders comprise 10-30% chromium, 5-250 nickel, 0.5-3% manganese, 1-4% silicon and 0-3% by weight of molybdenum.

Powders having a similar chemical composition are known from the U.S. Pat. Nos. 3,980,444 and 4,964,909. These known powders are however used within the powder metallurgical field but, in contrast to the powders according to the present invention, the known powders are compacted and sintered to high densities.

As regards the silicon content this should be kept above 1% by weight to limit the oxygen content of the powder and below 4% by weight since higher silicon content does not lower the oxygen content further.

The powder according to the invention may be mixed with a binder and/or lubricant material to facilitate e.g. consolidation.

In one embodiment the powder may be spread onto a support to form a filter material. The filter material may be subsequently sintered. In another embodiment the powder is consolidated in a mould to form a filter element, with or without reinforcement.

A reinforcement may be provided the powder metal during manufacturing of a filter material. The reinforcement may be fibres, wire or mesh e.g. expanded metal. The reinforcement may in one embodiment be manufactured of a stainless steel material.

Sintering may be performed in hydrogen or vacuum atmosphere at a temperature of 1120° to 1350° C. In this context sintering may also include vaporisation of binder. The sintering and vaporisation may also be performed as separate treatments

Without being bound to any specific theory it is believed that manganese in the amounts according to the invention will reduce the oxidation of the filter at elevated temperatures and therefore extend the life of the filter. Oxidation will result in less permeability of the filter and hence the performance of the filter is deteriorated in a shorter period of time.

The invention is illustrated by the following non-limiting examples:

### EXAMPLE 1

Filter specimens were produced from the iron-based powder according to the invention and from an iron-based reference powder. The filter specimens were circular specimens having a diameter of 10 mm and a thickness of 0.5 mm. The filter specimens where manufactured to have a density of 40% of full density. The sintering was performed at 1250° C. for 30 minutes. In table 1 the chemical analysis in weight percent of various powders are presented. The reference powder is 310B, which is available from Höganäs AB, Sweden.

TABLE 1

| Material | % Cr % | % Ni | % Mn | % Si |
|---|---|---|---|---|
| REF | 24.9 | 20.8 | 0.0 | 2.67 |
| A | 22.4 | 20.4 | 1.03 | 2.44 |
| B | 24.4 | 19.7 | 2.03 | 2.01 |
| C | 24.6 | 20.2 | 3.03 | 2.45 |
| D | 24.8 | 20.0 | 4.02 | 2.86 |

The filter samples where then heated to a predetermined temperature of 800° C. for 2 minutes in air and then cooled to room temperature for 30 seconds. This cycle was then repeated for a period of 20 hours. Every 15th cycle the weight of the samples was recorded to measure the oxide build-up. The purpose of this test is to provoke and measure oxidation of the samples. In diagram 1 the dependency of time and weight increase is presented for each material tested. The effect of certain contents of manganese is clear. From diagram 1 it can be seen that a remarkable decrease in weight increase is achieved by adding manganese in a content of about 2% by weight. A preferred range for the manganese content is between 1% and 3%.

### EXAMPLE 2

Pressure drop measurements were performed to evaluate the performance of the filter after certain time of use. The measurements were performed by applying 0.5 bar compressed air on the inlet in a filter holding device. The pressure loss caused by the filter was then measured. All filters were tested before and after oxidisation. The pressure drop was then calculated as the difference between the oxidised and non-oxidised filter. In table 2 the results from the pressure drop measurements are presented. The weight increase in example 1 corresponds to the pressure drop which is presented in example 2. Therefore the weight increase illustrates the pressure drop.

TABLE 2

Material

| | |
|---|---|
| REF | B |

Specimen

| | 1 | 2 | 3 | 4 | 5 | 6 |
|---|---|---|---|---|---|---|
| Pressure | 11 | 11 | 17 | 3 | 3 | 5 |
| drop (%) | | | | | | |

1. A filter comprising porous sintered stainless steel, including 10-30% by weight of chromium, 5-25% by weight of nickel, 1-3% by weight of manganese, 1-4% by weight of silicon, and 0-3% by weight of molybdenum, with the remainder being iron and inevitable impurities, said sintered stainless steel having a density less than 80% of full density.

2. The filter according to claim 1 having a density less than 70% of full density.

3. The filter according to claim 1 having a density between 25% and 60% of full density.

4. The filter according to claim 1 further comprising reinforcement.

5. The filter according to claim 4, wherein the reinforcement is in the form of fibers, wire, or mesh.

6. A steel powder for the preparation of a filter having improved permeability when used at high temperatures, wherein said steel powder consists of 10-30% by weight of chromium, 5-25% by weight of nickel, 1-3% by weight of manganese, and 1-4% by weight of silicon, with the remainder being iron and inevitable impurities.

7. A metal powder comprising 10-30% by weight of chromium, 5-25% by weight of nickel, 1-3% by weight of manganese, 1-4% by weight of silicon, and 0-3% by weight of molybdenum, with the remainder being iron and inevitable impurities.

8. The filter according to claim 2 further comprising reinforcement.

9. The filter according to claim 3 further comprising reinforcement.

10. The filter according to claim 8 wherein the reinforcement is in the form of fibers, wire, or mesh.

11. The filter according to claim 9 wherein the reinforcement is in the form of fibers, wire, or mesh.

12. The filter according to claim 1 comprising about 2% by weight manganese.

13. The steel powder according to claim 6 comprising about 2% by weight manganese.

14. The metal powder according to claim 7 comprising about 2% by weight manganese.
